(19) United States
(12) Patent Application Publication
(10) Pub. No.: US 2022/0284483 A1
(43) Pub. Date: Sep. 8, 2022

(54) PRIVATE VIEWING OF PERSONALIZED ADVERTIZING CONTENT IDENTIFIED BY AUTONOMOUS ONLINE CONTENT PLATFORMS

(71) Applicant: The Open University, Raanana (IL)

(72) Inventors: RICA GONEN, Petach Tikva (IL); MORAN FELDMAN, Yokneam Illit (IL)

(21) Appl. No.: 15/828,289

(22) Filed: Nov. 30, 2017

Related U.S. Application Data
(60) Provisional application No. 62/476,978, filed on Mar. 27, 2017.
(60) Provisional application No. 62/484,437, filed on Apr. 12, 2017.
(60) Provisional application No. 62/530,352, filed on Jul. 10, 2017.

(51) Int. Cl. G06Q 30/02

(52) U.S. Cl. CPC G06Q 30/0275; G06Q 30/0277; G06Q 30/0269

(57) ABSTRACT

A system and method for mediated online-advertising providing financially-incentivized, anonymous user-viewing of personalized advertising content through an automated databroker system configured to construct user groups and user group bundles from user profiles and match the user groups and user group bundles with personalized advertiser content received from advertisers in accordance with market stabilizing criteria.

### CROSS REFERENCE TO RELATED APPLICATIONS

This application claims the benefit of provisional application Ser. No. 62/476,978, filed on Mar. 27, 2017, Ser. No. 62/484,437, filed on Apr. 12, 2017, and Ser. No. 62/530,352, filed on Jul. 10, 20117; are all incorporated in their entirety herein by reference.

### GOVERNMENT INTEREST STATEMENT

The project leading to this application has received funding from the European Union's Horizon 2020 research and innovation programme under grant agreement No 653449.

### BACKGROUND OF THE INVENTION

Billions of daily, online transactions drive major online advertising campaigns. To increase advertising effectivity, advertisers frequently collect large amounts of personal information that give rise to serious privacy concerns. In recent years national regulators have addressed these concerns and facilitated the development of tools enabling users to configure their privacy settings; however, many of these schemes fail to provide the desired privacy. On the other hand, advertisers committed to developing suitable and effective advertising content have developed strategies to profile end-users based on tracking heuristics. These techniques also fall short in providing sufficient personal information enabling the development of effective, individualized advertising content.

Therefore, there is a need for an online advertising scenario providing complete user privacy and sufficient user information enabling advertisers to develop relevant and effective advertising content.

### SUMMARY OF THE INVENTION

According to the teachings of the present invention there is provided method for implementing online, mediated advertising, performed on a databroker system including a plurality of network-enabled mediators coupled to a databroker, each of the mediators and the databroker having a processor, memory, and one or more code sets stored in the memory and executed in the processor, the method including: receiving a plurality of user profiles from users by a first mediator of the plurality of mediators; designating a user group feature profile defining a first user group; identifying a user group of users from the user profiles having features matching the group feature profile; receiving a plurality of personalized advertisement profiles from an advertisement provider, each advertisement profile associated with its respective personalized advertising content; using an assignment mechanism to assign a personalized advertisement profile to the first user group by the databroker; and enabling viewing of the personalized advertising content by each of the users of the first group while concealing identity of each of the users of the first user group from the advertisement provider, wherein each of above steps is implemented by the databroker system.

According to a further feature of the present invention, the using an assignment mechanism includes Price by Removal Mechanism (PRM) filtering users on a basis of user asking price greater than user asking price of users of other mediators.

According to a further feature of the present invention, the PRM includes filtering advertisers on a basis of advertiser offering price being less than offering price of other advertisers.

According to a further feature of the present invention, the using an assignment mechanism includes Threshold by Partition Mechanism (TPM) filtering users on a basis of payment thresholds.

According to a further feature of the present invention, the filtering users on a basis of payment thresholds includes: randomly dividing mediators and advertises into a first and a second pool, each of the pools has mediators and advertisers, establishing a first-pool threshold and a second-pool threshold, and filtering users of the second pool with the first-pool threshold and filtering users of the first pool with the second-pool threshold.

According to a further feature of the present invention, the assignment mechanism includes Observe and Price Mechanism (OPM) filtering users on a basis of payment thresholds established during a sampling period of bidding prices of user and advertisers.

According to a further feature of the present invention, the enabling viewing of the personalized advertising content is implemented by enabling remote viewing of the content stored on the databroker system.

According to a further feature of the present invention, the enabling viewing of the personalized advertising content is implemented by sending the content to the users.

According to a further feature of the present invention, there is also provided identifying users having access to the personalized advertising content from the first user group, the access selected from the group consisting of a receipt of the content, a mouse click associated with the content, a user selection of an option presented in the content, a tracked-eye motion indicative of content viewing.

According to a further feature of the present invention, there is also provided causing a payment transfer to the users having access to the personalized advertising content.

There is also provided according to the teachings of the present invention, an online, mediated advertising platform including: a databroker system including a plurality of network-enabled mediators coupled to a databroker, wherein the mediators are configured to: receive a plurality of user profiles from users; identify a first group of users from the user profiles having features matching a first group feature profile; receive a first advertisement profile from an advertisement provider, each advertisement profile associated with its respective personalized advertising content; provide access of the personalized advertising content by users of the user group responsively to assignment of the personalized advertisement profile to the first user group; and wherein the databroker is configured to: use an assignment mechanism to assign a personalized advertisement profile to the user group.

There is also provided according to the teachings of the present invention, using an assignment mechanism includes Price by Removal Mechanism (PRM) filtering users on a basis of user asking price greater than user asking price of users of other mediators.

There is also provided according to the teachings of the present invention, the PRM wherein the PRM includes filtering advertisers on a basis of advertiser offering price being less than offering price of other advertisers.

There is also provided according to the teachings of the present invention, the assignment mechanism includes Threshold by Partition Mechanism (TPM) filtering users on a basis of payment thresholds.

There is also provided according to the teachings of the present invention, the filtering users on a basis of payment thresholds includes: randomly dividing mediators and advertises into a first and a second pool, each of the pools has mediators and advertisers, establishing a first-pool threshold and a second-pool threshold, and filtering users of the second pool with the first-pool threshold and filtering users of the first pool with the second-pool threshold.

There is also provided according to the teachings of the present invention, the assignment mechanism includes Observe and Price Mechanism (OPM) filtering users on a basis of payment thresholds established during a sampling period of bidding prices of user and advertisers.

There is also provided according to the teachings of the present invention, the enable viewing of the personalized advertising content is implemented by sending the content.

There is also provided according to the teachings of the present invention, each of the mediators is further configured to identify users having access to the personalized advertising content from the first user group, the access selected from the group consisting of a receipt of the content, a mouse click associated with the content, a user selection of an option presented in the content, a tracked-eye motion indicative of content viewing.

There is also provided according to the teachings of the present invention, each of the mediators is further configured to cause a payment transfer to the users having access to the personalized advertising content.

### BRIEF DESCRIPTION OF THE DRAWINGS

The subject matter regarded as the invention is particularly pointed out and distinctly claimed in the concluding portion of the specification. The invention, however, both as to organization and method of operation, features, and advantages thereof, may best be understood in reference to the following detailed description in view of the accompanying drawings.

FIG. 1 is a schematic view of a current online advertising scheme in the absence of a databroker;

FIG. 2 is a schematic view of a mediated online advertising scheme for multiple users and advertising campaigns mediated by databroker platform, according to an embodiment;

FIGS. 3A-3C are schematic block diagrams of a user computing device, a mediator computing device, and a databroker computing device, respectively, according to an embodiment;

FIGS. 4A-4B are sample user and ad campaign profiles, respectively, submitted to the databroker system, according to an embodiment;

FIG. 5 is a general flow chart depicting the steps implementing multi-sided, mediated online advertising by the databroker platform, according to an embodiment; and

FIGS. 6-8 are detailed flow charts of the general flow chart depicting in FIG. 5.

It will be appreciated that depicted elements are not drawn to scale and may be exaggerated for the sake of clarity. Further, reference numerals may be repeated among the figures to indicate corresponding or analogous elements.

### DETAILED DESCRIPTION OF THE PRESENT INVENTION

In the following detailed description, numerous details are set forth in order to provide a thorough understanding of the invention. However, it will be appreciated by those skilled in the art that the present invention may be practiced without these specific details. Furthermore, well-known methods, procedures, and components have been omitted to highlight the features and methods of the present invention.

The present invention is an economically resilient, online, mediated advertising platform directed at protecting user privacy and providing personalized advertising content.

Generally, a databroker interfaces between mediators and advertisers in the online advertising market. Each user supplies a user profile to a mediating party, also referred to as mediator, in communication with the databroker in exchange for compensation and the databroker can in turn sell the user profiles on the advertising market without disclosing user identity. To encourage users to share information they are compensated in accordance with fees paid to the mediator by the advertising provider.

This advertising scheme advantageously incentivizes users to supply personal information useful to advertisers and preserves user privacy. This is a significant improvement over traditional privacy control schemes like cryptography and other machine learning regarding both the quality of personal information gleaned from the users and the extent of user privacy safeguarded. Furthermore, the databroker system is configured to contribute to market resiliency by reducing the effectiveness of detrimental practices by market participants.

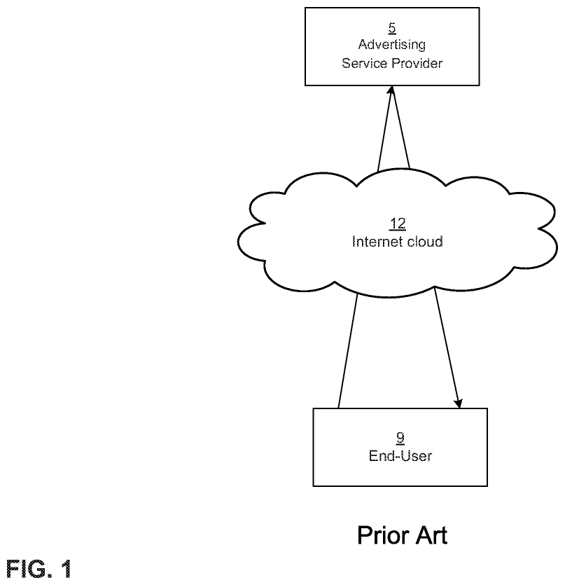

Turning now to the figures, FIG. 1 is a schematic view of a current online advertising scheme in the absence of a databroker in which an advertising service provider 5 is in direct communication with an end-user 9 through the internet cloud 12. In this scenery, advertisers typically extract as much information from end user 9 to craft effective user oriented advertising campaigns and it is incumbent on end-user to take various cautionary measures to prevent dissemination of personal information among advertisers, as noted above.

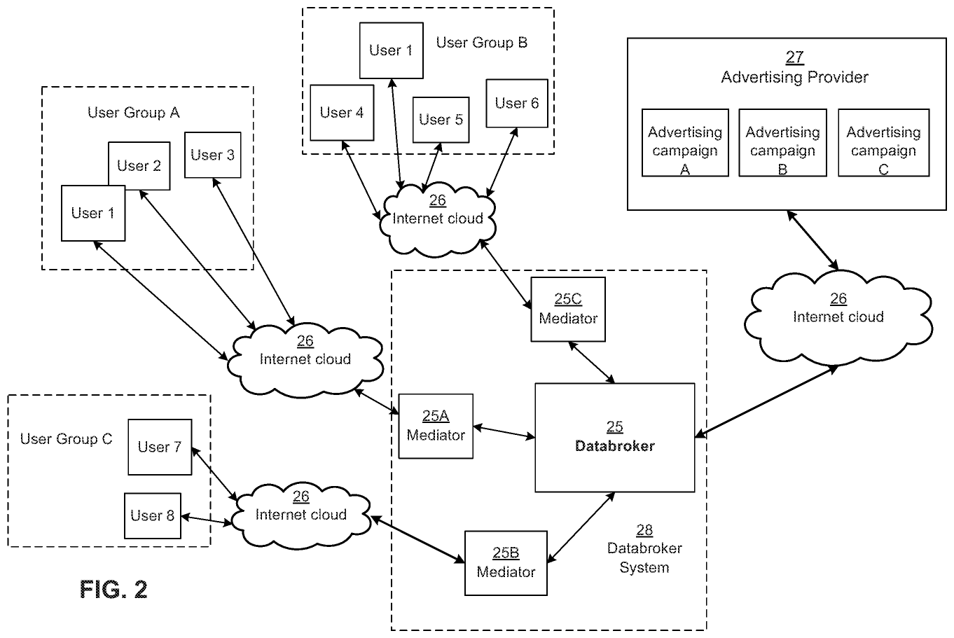

FIG. 2 is a schematic view of an online, databroker system 28 including a databroker 25 interfacing with multiple mediators 25A-25C in communication with users 1-9 and also interfaces with various advertisers A-C though an internet cloud 26 to enable databroker 25 to assign mediator-defined user groups and user-group bundles to a personalized advertising campaigns as will be further discussed.

As noted, each of mediators 25A-25C defines a user group or groups in accordance with features from a submitted user profile matching a group-defining feature profile designated by a mediator in accordance with predefined criteria. Group A is defined, for example, by a particular feature profile and Users 1-3 are associated with Group A after being identified by a mediator 25A as having such features. Similarly, Groups B and C are also defined by their respective feature profiles and their members are included based on their possession of features matching the group feature profile. As shown, Users 1, and 4-6 are associated with User Group B and Users 7-8 are associated with User Group C. User 1 is a member of both Groups A and B because User 1 possesses features matching the group profile of both Group A and Group B. A single user can be grouped into different user groups in accordance with mediator profile definitions. Consequently, hundreds or thousands of user groups can be identified and the number of group members associated with any particular group can be defined in accordance with mediator definitions.

As shown, mediators 25A-26C interface with databroker 25 through which they communicate with an advertisement provider 27 having advertising campaigns A-C. It should be appreciated, that in a certain embodiment, any of the mediators is in communication with one or more advertising providers directly; not through databroker 25. Each campaign has a target feature set and content directed to that feature set to advantageously provide personalized adverting content appropriate for users possessing those target features. The content is provided to the appropriate mediator through databroker 25 where assignments of user groups and advertisement campaigns are implemented on a mediator basis. All mediators 25A-C are also configured to enable viewing of the personalized content in the absence of advertiser tracking or knowledge of user identity, interests, conduct, or other undisclosed personal information.

It should be appreciated that in a certain embodiment, the internet is implemented as private internal network of a multi-department organization.

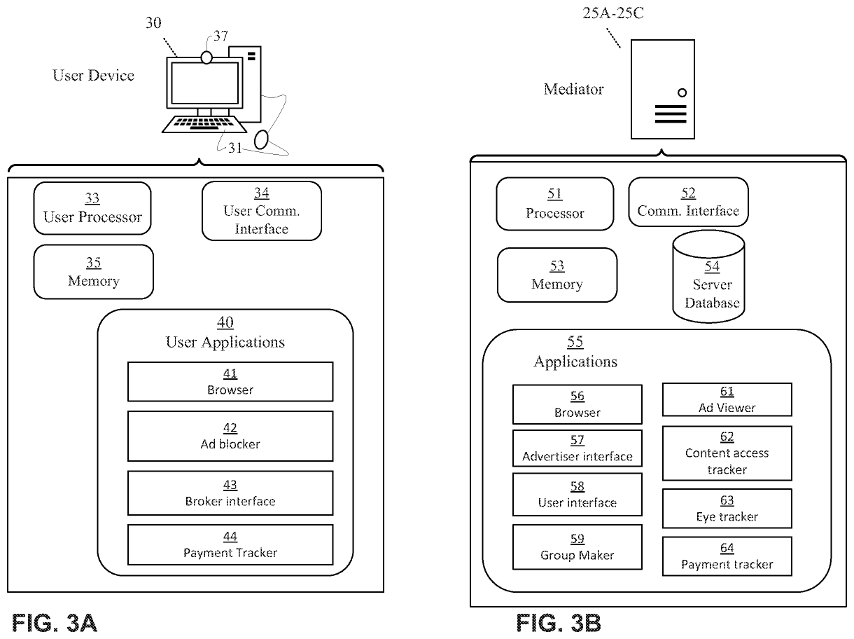

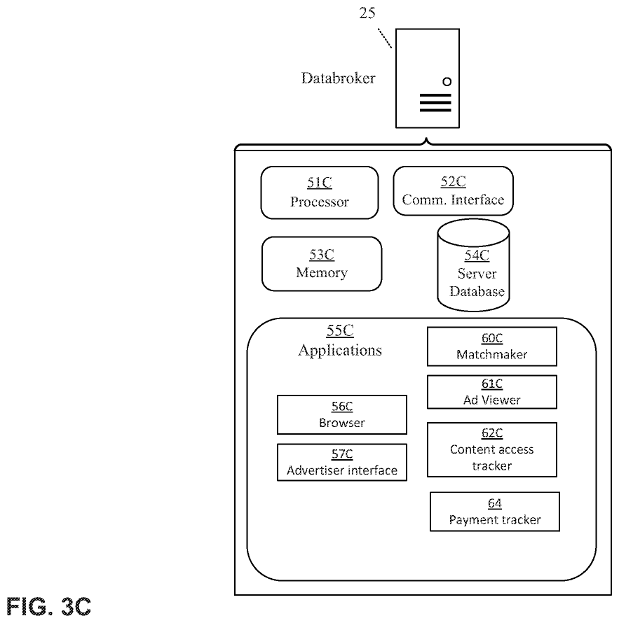

FIG. 3A is a schematic block diagram of a user computing device including a user processor 33, user memory 35, and user communication interface 34, one or more input devices 31, a mediator-linked device 37 configured to track eye movement, and output devices 36, and user applications 40.

User applications 40 include software enabling anonymous viewing of personalized advertising content through automated databroker 25 as discussed above.

Specifically, applications 40 include a browser 41, an ad blocker 42 to block non-broker ad content, a broker interface 43 configured to submit user features, compensation expectations, and to anonymously view personalized advertising content, and a payment tracker 44 configured to track payments initiated by databroker 25 in compensation for user features supplied and then purchased by an advertiser, according to an embodiment.

It should be appreciated that in a certain embodiment these applications are implemented in a single stand-alone software package while in another embodiment each of or a combination of the applications are implemented as separate software modules.

FIG. 3B is a schematic block diagram of any one of mediators 25A-25C of databroker system 28 and includes processor 51, network interface 52, memory 53, a data base 54, and mediator applications 55.

The mediator application package 55 includes software directed to constructing user groups and user-group bundles from user profiles submitted by users and preserving user privacy when accessing personalized content.

Such software applications include, inter alia, a web browser 56 for viewing advertising content, advertiser interface 57 configured to accept advertisement profiles and provide relevant feedback to advertisement providers, user interface 58 configured to accepts user profiles and provide relevant feedback to the users, a group maker 59 configured to form user groups or user-group bundles from a common features identified among various user profiles submitted to a mediator, ad viewer 61 enabling remote viewing of personalized advertisement content by users of assigned user groups, and an ad viewing tracker 62 configured to track advertisement access of users, eye-tracker 63 configured to track user eye motion to identify if viewing of ad content, a payment tracker 64 configured to enable a payment tracking received from advertisers and compensation fees transferred to users responsively to access of personalized advertising content. It should be appreciated that in a certain embodiment, mediator applications 55 are implemented as a stand-alone software package whereas in another embodiment they are implemented separately.

Regarding various hardware embodiments, mediators 25A-C are implemented as autonomous network-enabled servers.

Mediators 25A-25C of databroker system 28 interface with the Internet or a private network via communication interface 52 implemented as any of devices like a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection.

Memory 53 may be, for example, a random-access memory (RAM) or any other suitable volatile or non-volatile computer readable storage medium. In addition, memory 53 and may be fixed or removable, local or remote to a mediator platform.

In accordance with further embodiments of the invention, a mediator 25 is in communication with one or more database(s) 54, located either locally or remotely via a network. In some embodiments, database 54 contains information relating to user and advertisement profiles or analysis of such information. In some embodiments, database 54 may be a database of a third-party administrator server, e.g., of an information administrator tasked with collecting information. It should be appreciated that third party mediators employing plugins or applications providing such functionality are also included in the scope of the invention.

FIG. 3C is a schematic block diagram of databroker 25 of databroker system 28 and includes processor 51C, network interface 52C, memory 53C, a data base 54C, and broker applications 55.

The databroker application package of 55C includes software providing assignments of personalized advertising packages with user groups and user-group bundles.

Such software applications include, inter alia, a web browser 56C for viewing advertising content, advertiser interface 57C configured to accept advertisement profiles and provide relevant feedback to advertisement providers, user interface 58C configured to accepts user group and user-bundle profiles, a matchmaker 65C configured assign user groups and user-group bundles with advertising campaigns having a sufficiently matching target profiles, and an ad viewing tracker 62 configured to track advertisement access of mediators, a payment tracker 64C configured to enable a payment tracking received from advertisers and compensation fees transferred to mediators responsively to access of personalized advertising content. It should be appreciated that in a certain embodiment, broker applications 55C are implemented as a stand-alone software package whereas in another embodiment they are implemented separately.

Regarding various hardware embodiments, databroker 25 is implemented as autonomous network-enabled servers.

Interface with the Internet or a private network is achieved via a communication interface 52C implemented as any of devices like a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection.

Memory 53C may be, for example, a random-access memory (RAM) or any other suitable volatile or non-volatile computer readable storage medium. In addition, memory 53 and may be fixed or removable, local or remote to a mediator platform.

In accordance with further embodiments of the invention, a databroker 25 is in communication with one or more database(s) 54C, located either locally or remotely via a network. In some embodiments, database 54C contains information relating to user and advertisement profiles or analysis of such information. In some embodiments, database 54C may be a database of a third-party administrator server, e.g., of an information administrator tasked with collecting information.

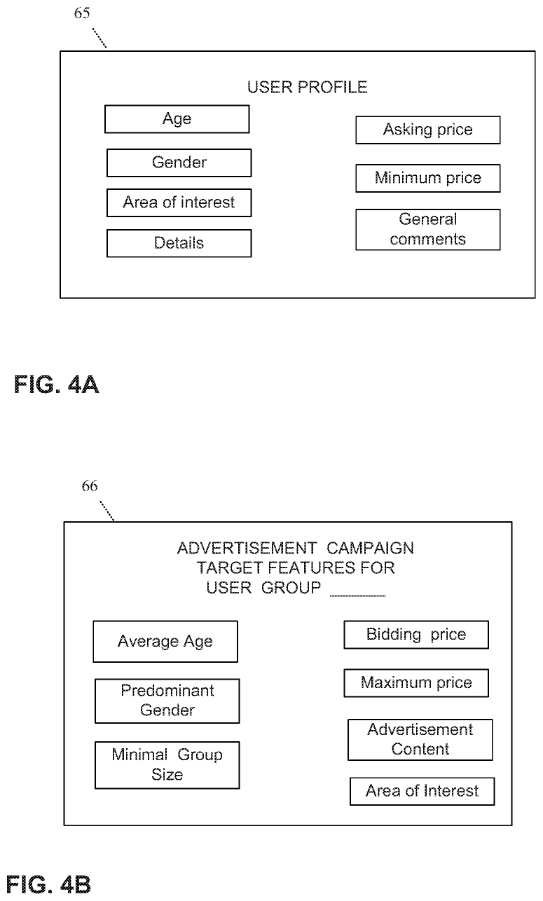

FIG. 4A is sample user profile page 65 provided by each databroker user and received by mediators 25A-25C of databroker 25, according to an embodiment. As shown, typical information that can be used to construct a user group includes, inter alia, age, gender, general and specific areas of viewing interest, asking price for personal information, a minimum asking price, and other general comments furthering adding to a user profile. It should be appreciated that any relevant information can be included in the user profile and can even be directed by advertisers requiring certain target features. Generally, providing greater number of features will cause the user to be assigned to multiple groups; each having a different group profile. This leads to users being assigned to multiple advertising campaigns each having a different advisement profile. The profile is typically provided online through database interface 52 and stored in a data base 54 shown in FIG. 3.

FIG. 4B is sample advertiser profile page 66 provided for each advertising campaign by one or multiple advertisers and received by databroker 25, according to an embodiment. As shown, typical target features include, inter alia, average user group age, predominant gender, minimal user group size, ideal bidding price willing to pay to for personal information, maximum bidding price, and a description of the advertising content directed to a user group having the noted target features. It should be appreciated that any relevant information can be included in the ad profile and can even be defined by dominant user features collected by databroker 25 in a certain embodiment.

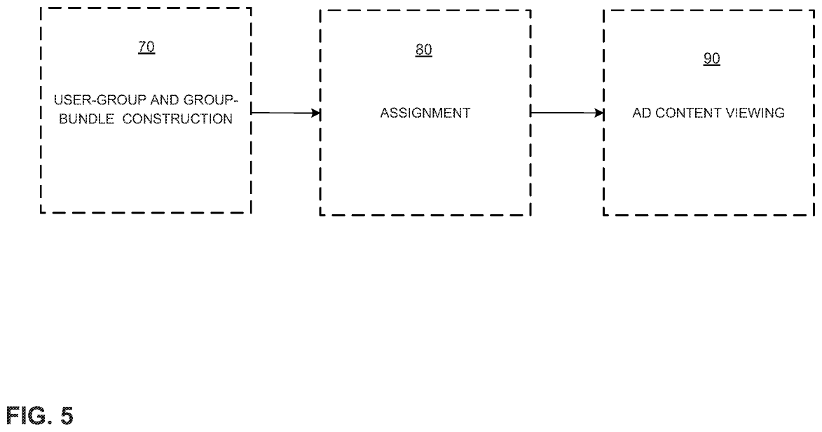

FIG. 5 is a general flow chart depicting the steps employed by an embodiment of the databroker implementing multi-sided, online mediated advertising in three stages, a user group construction stage 70, an assignment stage 80, and an advertisement viewing stage 90, according to an embodiment.

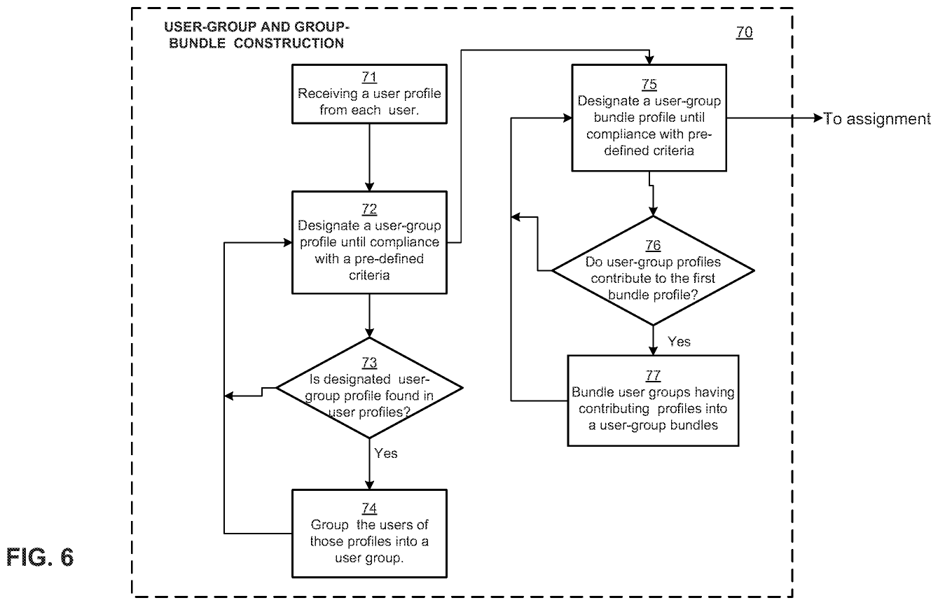

FIG. 6 is a detailed flow chart of the user group construction stage 70 depicted in FIG. 5. As shown, in step 71 the mediator receives user profiles of each potential user. The content of the user profile received is set forth above in the context of FIG. 4A.

In step 72, a group profile of user features is designated in accordance with pre-defined criteria. The feature set includes one or more user features as discussed above. In a certain embodiment, the group profile is defined by the target features set forth by an advertiser.

In step 73, processing is directed in accordance with identification of the designated group profile among the user profiles. Users having the designated profile are grouped together as a group associated with a first user profile as shown in step 73. If the users lack the designated feature set, processing continues to step 76 to determine if users have another profile set designated in step 75. If another profile is found among the users, they are grouped together in step 77 as a user group having a second user profile and processing continues to the assignment stage.

As shown, in processing steps 75-77 continue to generate additional group profile designations, identifications, and groupings until all or a predefined number of users have been evaluated, or until compliance with another pre-defined another criterion. It should be appreciated that in a certain embodiment, the designated group profile is set by one or more advertisers.

It should be appreciated that in a certain embodiment, the databroker is configured to weight user features according to a pre-defined weighting scheme to advantageously enable grouping flexibility to comply with target profiles provided by advertisers or other interested parties.

After construction of the user groups, processing continues into the assignment stage 80.

In step 81, target group profiles associated with direct ad content is received by the databroker from an advertiser. In a certain embodiment content is received iteratively after assignment as to appropriate user groups as shown; however, in certain embodiments multiple target profiles are received and stored until an assignment is made. The ad profile can include a feature specific variance to increase the scope of what is deemed a proper match between a user-group profile and an ad profile, as noted above.

In step 82, an assignment between the users and advertisers based on received profiles from users and target profiles from the advertisers. It should be appreciated that economic policy makers typically work to implement economic policy to ensure long term market health by minimizing market manipulation and market deficit. Frequently, market participants focused on immediate profits don't function in accordance with such economic guidelines thereby leading to a dysfunctional market. The databroker system, or mediator, is configured to use long terms policy considerations as operational criteria embodied in various assignment mechanisms employed to assign users and advertisers to facilitate economic resiliency based on various assignment mechanisms.

In a first embodiment of the assignment mechanism employs a deterministic mechanism, Price by Removal Mechanism” (PRM), assuming public knowledge of the intended scope of an advertiser campaign in accordance with the following process.
1. Establish cost thresholds without knowledge of true mediator user costs; but rather only those mediator costs reported to the databroker so as to advantageously prevent manipulation of cost thresholds by market participants.
2. Appling the cost threshold to filter out users from a pool of potential users eligible for assignment to an advertiser on a basis of an asking price relative to the asking price of users of other mediators.
3. Appling the price threshold to filter out advertisers from the pool of potential advertisers eligible for assignment to users on a basis of an advertiser price less than other advertiser prices.

Formally, assuming that PRM has access to a value γ≥1 such that:

u(a)≤γ∀a∈A and |P(m)|≤γ∀m∈M.

Wherein:

u(a) is a number of users to which an advertiser wants to advertise.
γ is an upper bound of advertiser capacity or the number of mediator users. Informally, γ can be understood as a bound on the market significance of every single advertiser or mediator can have.
“a” is an advertiser.
“m” is a mediator or databroker unit.
P(m) is the number of users a mediator m has in a particular profile.

Unknown model parameters unknown to the assignment mechanism (i.e., values of advertiser, the number of users of mediators and the costs of users). are understood to be reported values.
1. For every mediator, m∈M, if the canonical assignment Sc(P\P(m),B) is of size more than 4γ, denote by pm the user at location |Sc(P\P(m),B)|−4γ of the canonical assignment Sc(P\P(m), B), and let cm be the cost of pm. Otherwise,
2. For every mediator m∈M, let \hat{P}(m) be the set of users of mediator m whose cost is less than cm. Intuitively, \hat{P}(m) is the set of users of mediator “m” that the mechanism tries to assign to advertisers.
3. Assign the users of Sₘ∈M \hat{P}(m) to the advertisers using a VCG auction. More specifically, the users of Sₘ∈M \hat{P}(m) are the items sold in the auction, and the bidders are the advertisers of A plus a dummy advertiser ad whose value and capacity are v(ad)=max m∈M cm and u(ad)=Pₘ∈M|\hat{P}(m)|, respectively.

In as second embodiment, the assignment mechanism is implemented as a randomized mechanism; “Threshold by Partition Mechanism” (TPM) that does not assume public knowledge about the advertiser capacity thereby providing the advertisers with multi-dimensional strategy spaces. This assignment mechanism is based on a payment threshold as opposed to the cost threshold set forth above. The payment threshold is implemented as a two-sided payment threshold; one for advertiser payment to databrokers as well as databroker payment to users.
1. All mediators and advertisers are randomly divided into two pools by the databroker, each pool having mediators and advertisers.
2. Threshold user costs and threshold advertiser prices are calculated separately for each of the two pools. Threshold user costs and advertiser prices established for the first pool are used for the mediators and advertises of the second pool, and analogously, threshold user costs and advertiser prices established for the second pool are used for the mediators and advertises of the first pool. This scheme prevents manipulation of the mediator feature costs and values advertiser are offering to pay. The location in a canonical assignment in a pool defines the user cost threshold and advertiser price threshold.
of users and advertisers defines the payment threshold in certain instances.
3. Advertisers and users are assigned in accordance with the respective payment thresholds.

In formal terms, TPM assumes access to a value α∈[|S_{c}(P, B)|⁻¹, 1] so as to guarantee that: u(a)/|S_{c}(P, B)|≤α∀a∈A and |P(m)|/|S_{c}(P, B)|≤α∀m∈M. In other words, α is an upper bound on advertiser capacity in regards to the number of users of a mediator compared to the size of the optimal assignment S_{c}(P, B), wherein a is related to the value γ by α=γ/τ, and thus, α, like γ, can be informally understood as a bound on the market significance of every single advertiser or mediator. It is important to note that α is well-defined only when |S_{c}(P, B)|>0.

A description of TPM is given as assignment mechanism 2, or alternatively mechanism 2. It should be appreciated that when mechanism 2 refers to unknown model parameters like the value of an advertiser or the number of users of a mediator. It should be understood that such unknown parameters refer to their reported values.
1. Let M_{L} be a set of mediators containing each mediator m∈M with probability min{17 ∛α, 1}, independently. Similarly, A_{L} is a set of advertisers containing each advertiser a∈A with probability min{17∛α, 1}, independently. Intuitively, the subscript L in M_{L} and A_{L} stands for “low priority”.
2. Let σ_{A} be an arbitrary order over the advertisers that places the advertisers of A_{L} after all the other advertisers and is independent of the reports received by the mechanism. Similarly, σ_{M} is an arbitrary order over the mediators that places the mediators of M_{L} after all the other mediators and is independent of the reports received by the mechanism.
3. Partition the mediators of M into two sets M₁ and M₂ by adding each mediator m∈M of any of a variety of probabilities, independently, to M₁ and otherwise to M₂. Similarly, partition the advertisers of A into two sets A₁ and A₂ by adding each advertiser “a” ∈A of any of a variety of probabilities, independently, to A₁ and otherwise to A₂. The rest of the algorithm explains how to assign users of mediators from M₁ to slots of advertisers from A₁, and how to charge advertisers of A₁ and pay mediators of M₁. Analogous steps, are used for handling the advertisers of A₂ and the mediators of M₂.
4. Let \hat{p} and \hat{b} the user and slot at location [(1−4(∛α)). |S_{c}(P(M₂), B(A₂))|] of the canonical solution Sc(P(M₂), B(A₂)). If (1−4(∛α))·|S_{c}(P(M₂), B(A₂))|≤0, then the previous definition of \hat{p} and \hat{b} cannot be used. Instead define p as a dummy user of cost −∞ and \hat{b} as a dummy slot of value ∞. Using \hat{p} and \hat{b} define now two sets:

\hat{P}={p∈P(M₁)|c(p)<c(\hat{p})}

and

\hat{B}={b∈B(A₁)|v(b)>v(\hat{b})}.
It should be noted that \hat{P} and \hat{B} are empty whenever \hat{p} and \hat{b} are dummy user and slot, respectively.
5. While there are unassigned users in \hat{P} and unassigned slots in \hat{B} do the following:
   Let m be the earliest mediator in σ_{M} having unassigned users in P.
   Let a be the earliest advertiser in σ_{A} having unassigned slots in \hat{B}.
   Assign the unassigned user of \hat{P}∩P(m) with the lowest cost to an arbitrary unassigned slot of \hat{B}∩B(a), charge a payment of v(\ddot{p}) to advertiser a and transfer a payment of c(\hat{p}) to mediator m.

Following are possible relaxations of the formal steps of mechanism 2.
In step 1 every low probability is ok.
In step 3 any probability and not just ½ is possible.
In step 4 the location of \hat{p} and \hat{b} can be computed with different formula not necessarily the one appearing.

In yet another embodiment a third assignment mechanism operates in real time and therefore has no prior knowledge of users, advertisers, or bidding prices. Therefore, there is a sampling period in which the databroker receives user profiles and target profiles associated with advertisers. The duration of the sampling period is randomly selected to minimize manipulation by users or advertisers.

The sampling period is determined by the desired level of accuracy of the estimated market price. After the sampling period, a threshold payment is generated as described in the previous algorithm.

The threshold payment is then used as the assignment basis of user groups and advertisers. Payment to users is implemented differently depending on the degree of assignable users assigned to advertisers:

If all assignable users of a databroker were indeed assigned, then each user is paid the threshold payment set forth by the algorithm after the sampling period even if the user request was less than the advertiser bid.

If not all assignable users were actually assigned to the advertiser because of a lack of advertiser volume, then each of the assigned users of a databroker are paid the minimum asking price among the assignable users of that particular databroker.

This mechanism is databroker specific and is designed to minimize jealousy between assignable unassigned users and assigned users.

Formally:
1. Draw a random value t from the binomial distribution B(|A|+|M|, r), and observe the first t entities that arrive without assigning any users. Let AT and MT be the set of the observed advertisers and mediators, respectively. More formally, if T is the set of the first t entities that arrived, then AT=A∩T and MT=M ∩T. We later refer to this step of the mechanism as the “observation phase”.
2. Let \hat{p} and \hat{b} be the user and slot at location [(1−2r−1·√3α)·|Sc(P(MT),B(AT))|] of the canonical assignment Sc(P(MT),B(AT)). If (1−2r−1·√3α)·|Sc(P(MT),B(AT))|≤0, then the previous definition of \hat{p} and \hat{b} cannot be used. Instead define \hat{p} as a dummy user of cost −∞ and \hat{b} as a dummy slot of value ∞. We say that a slot b or a user p corresponding to an entity that arrived after the observation phase is assignable if v(b)>v(\hat{b}) or c(p)<c(\hat{p}), respectively.
3. Let σ_{E} be the sequence of the entities that arrived so far after the observation phase. Initially E is empty, and entities are added to it as they arrive.
4. For every arriving entity:
   a. Add the new entity to the end of σ_{E}.
   b. If the arriving entity is a mediator m, then, as long as “m” has unassigned assignable users and there is an advertiser in σ_{E} having unassigned assignable slots, do the following:
      Let a be the earliest advertiser in σ_{E} having unassigned assignable slots.
      Assign the unassigned assignable user of m with the lowest cost to an arbitrary unassigned assignable slot of a, charge an amount of v(b) from advertiser “a” and pay c(\hat{p}) to mediator m.
   c. If the arriving entity is an advertiser a, then, as long as a has unassigned assignable slots and there is a mediator in σ_{E} having unassigned assignable users, do the following:
      Let “m” be the earliest mediator in σ_{E} having unassigned assignable users.
      Assign the unassigned assignable user of “m” with the lowest cost to an arbitrary assignable slot of “a”, charge an amount of v(\hat{b}) from advertiser “a” and pay c(\hat{p}) to mediator “m”.
   d. For every mediator m∈σ_{E}, recommend m to transfer his assigned users an additional amount that guarantees the following:
      If all the assignable users of m are assigned to slots, then the additional amount should increase the total payment received so far by each assigned user of m to c(\hat{p}).
      Otherwise, let p be the unassigned assignable user of m with the minimum cost. In this case the additional amount should increase the total payment received so far by each assigned user of m to c(p).

Below is a possible relaxation of the formal requirements of a third assignment mechanism
In step 1, t can be withdrawn from any distribution.
In step 2, the location of \hat{p} and \hat{b} can be computed with different formula not necessarily the one appearing.
In step 4a, the entities can be added in any order.
In step 4b, the slots and users can be matched in any order.
In step 4c, the whole payment scheme can be removed.

In a forth embodiment, the assignment mechanism is based on a transformation of a two-sided combinatorial market into a one-sided combinatorial auction such that one can conclude the allocation and prices of the buying agents as well as the allocation of the selling agents and the payments they receive; in which sellers are treated as users and buyers are treated as advertisers.
1. Initialize the prices of all commodities for the new agent that arrived.
2. Query the arriving agent for his demand or supply (depending on the type of agent) of commodities given the current prices.
3. Handle selling agents by converting each arriving selling agent in to a virtual buying agent. The virtual buying agent is configured to buy the commodities that the selling agent is better off keeping and not selling given the current market prices, i.e., his total commodities bundle Si minus the bundle of commodities that are most beneficial for him to sell according to his supply oracle si. Payment to the arriving agent is made every time his commodities are bought by future arriving buying agents. The payments are computed according to the prices that were presented to the selling agent at his arrival.
4. Handle buying agents by allocating each arriving buying agent his requested bundle at current prices and charging him according to those prices. Selling agents are paid for commodities that were bought by the currently arriving buying agent.
5. Update the prices of all commodities for the new agent that arrived.

Following are possible relaxations of the formal steps of assignment mechanism based on the transformation of a two-sided combinatorial market into a one-sided combinatorial auction.

Before the steps in the initialization stage, all parameters can be initialized differently.
In Step 1 the price initialization can be different.
In step 3 the rolls can reverse, i.e., it can be the case of buyers and virtual sellers.
In step 4 the change is a result of the other changes. (reverse rolls, different initialization)
In step 5 the update of the prices can use a completely different formula.

After assessment of suitability of the users and ad content, processing continues to step 83, in which an evaluation if a match between the group profile and ad profile of is performed. If found, processing continues to step 83 and the ad profile is assigned to a user group possessing the target profile. If the target profile is not found in the user group, then processing returns to step 81 where a different ad profile is received from an advertiser or retrieved from a cache of previously received profiles and evaluated for a match of a user group in step 82 as set forth above.

In step 83, processing is returned to step 81 until compliance with pre-defined criteria like either all target profiles or all user profiles have been evaluated or achievement of a threshold assignment or evaluation criteria.

After compliance of the criteria, a similar process is performed for group bundles in step 84 in which target-bundle profiles are received from advertiser.

Another decision is performed at step 85 in which an evaluation if received group profiles contribute to a group-bundle target.

If so, processing proceeds to step 86 where user groups having a group profile matching a portion of the group-bundle profile are each assigned to the bundle target.

If not, process flow continues to step 84 to receipt of additional group-bundle target and subsequent evaluation and bundle assignments are implemented in steps 85 and 86, respectively.

In step 86, here too processing is returned to step 84 until compliance with pre-defined criteria like either all target group-bundle profiles or all group profiles have been evaluated or achievement of a threshold assignment or evaluation criteria.

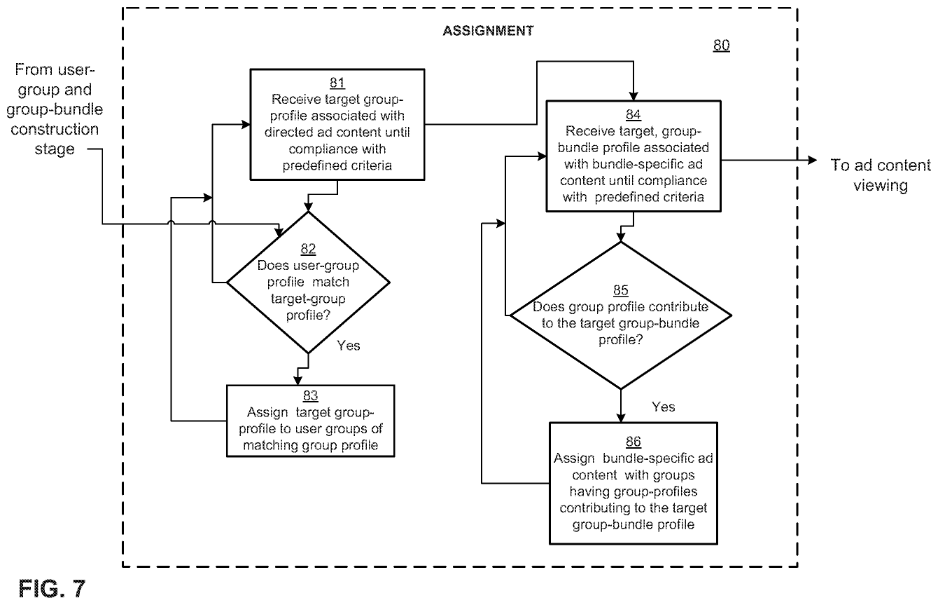

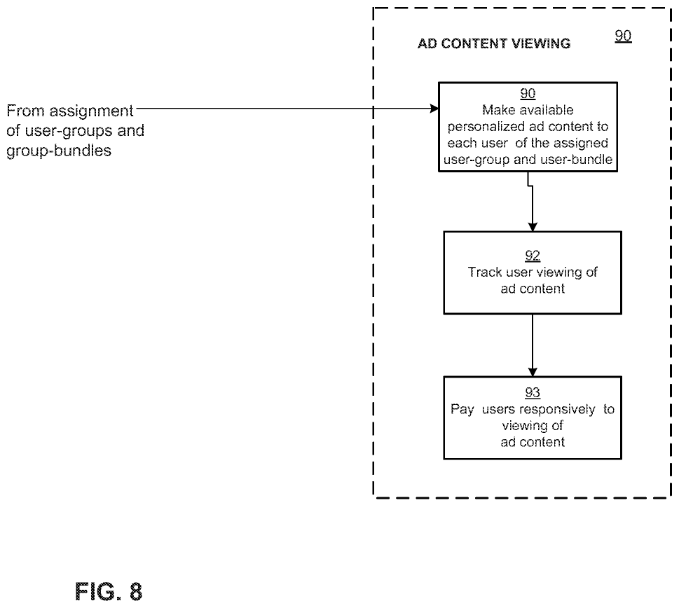

FIG. 7 depicts detailed steps of the content viewing stage 90 depicted FIG. 5 after assignment of the ad content to user groups and bundles.

In step 91 personalized advertising content now in the procession of the databroker is made available for viewing to the users of the respective, assigned user group. In a certain embodiment, viewing is implemented by enabling remote viewing of the personalized content stored at the databroker platform. In another embodiment, the personalized content is forwarded to each user of the relevant user group, whereas in another embodiment, both options exist and a user interface is provided to enable user viewing configuration as noted above. This arrangement advantageously enables advertising content personalized to the user in a manner preserving user anonymity from advertisers.

In step 92, the databroker tracks user access of the available personalized content through any of a variety of methods like, mouse click activity associated with content access, or receipt of the content or a link to the content, tracked eye-motion indicative of content viewing, user selection of an option presented in the content, in accordance with the embodiment. It should be noted that sending of the content by the system is deemed as user receipt of the content.

Responsively to content viewing, the databroker initiates a payment sequence for viewing of the content as set forth in step 93 be sending a payment instruction to a financial institution, in a certain embodiment.

Unless explicitly stated, the method embodiments described herein are not constrained to a particular order or sequence. Furthermore, formulas described herein are intended as examples only. It is understood that the appended claims cover equivalents within the spirit of the invention.

1. A method for implementing online, mediated advertising, performed on a databroker system including a plurality of network-enabled mediator computing devices coupled to a databroker computing device, each of the mediator computing devices and the databroker computing device having a processor, memory, and one or more code sets stored in the memory and executed in the processor, the method comprising:
receiving a plurality of user profiles from users by a first mediator computing device of the plurality of mediator computing devices;
wherein the plurality of mediator computing devices are implemented as autonomous network-enabled servers;
designating a user group feature profile defining a first user group;
identifying a user group of users from the user profiles having features matching the group feature profile;
receiving a plurality of personalized advertisement profiles from an advertisement provider, each advertisement profile associated with its respective personalized advertising content;
using an assignment mechanism to assign a personalized advertisement profile to the first user group by the databroker computing device, wherein the assignment mechanism includes a Price by Removal Mechanism (PRM) filtering users on a basis of user asking price greater than user asking price of users of other mediator computing devices;
establishing a cost threshold based only on those mediator computing device costs reported to the databroker computing device;
applying the cost threshold to filter out users from a pool of potential users eligible for assignment to an advertiser;
establishing a price threshold based only on those advertiser prices reported to the databroker computing device;
applying the price threshold to filter out advertisers from the pool of potential advertisers eligible for assignment to users; and
enabling viewing of the personalized advertising content by each of the users of the first group while concealing an identity of each of the users of the first user group from the advertisement provider,
wherein the PRM has an access to a value γ≥1 such that:
u(a)≤γ∀a∈A and |P(m)|≤γ∀m∈M,
wherein
u(a) is a number of users to which an advertiser wants to advertise,
γ is an upper bound of advertiser capacity or the number of mediator users,
a is an advertiser,
m is a mediator or databroker unit, and
P(m) is the number of users a mediator m has in a particular profile,
and
wherein each of above steps is implemented by the databroker system.

2. (canceled)

3. The method of claim 1, wherein the PRM includes filtering advertisers on a basis of advertiser offering price being less than offering price of other advertisers.

4. The method of claim 1, wherein the using an assignment mechanism includes a Threshold by Partition Mechanism (TPM) filtering users on a basis of payment thresholds.

5. The method of claim 4, wherein the filtering users on a basis of payment thresholds includes:
randomly dividing mediator computing devices and advertisers into a first and a second pool, each of the pools having mediator computing devices and advertisers;
establishing a first-pool threshold and a second-pool threshold; and
filtering users of the second pool with the first-pool threshold and filtering users of the first pool with the second-pool threshold.

6. The method of claim 1, wherein the assignment mechanism includes an Observe and Price Mechanism (OPM) filtering users on a basis of payment thresholds established during a sampling period of bidding prices of user and advertisers.

7. The method of claim 1, wherein the enabling viewing of the personalized advertising content is implemented by enabling remote viewing of the content stored on the databroker system.

8. The method of claim 7, wherein the enabling viewing of the personalized advertising content is implemented by sending the content to the users.

9. The method of claim 1, further comprising identifying users having access to the personalized advertising content from the first user group, the access selected from the group consisting of a receipt of the content, a mouse click associated with the content, a user selection of an option presented in the content, a tracked-eye motion indicative of content viewing.

10. The method of claim 9, further comprising causing a payment transfer to the users having access to the personalized advertising content.

11. An online, mediated advertising platform comprising:
a databroker system including:
a plurality of network-enabled mediator computing devices coupled to a databroker computing device, each of the mediator computing devices and the databroker computing device comprising;
a processor;
memory; and
one or more code sets executable by the processor,
wherein the plurality of network-enabled mediator computing devices are implemented as autonomous network-enabled servers; and
wherein the mediator computing devices are configured to:
receive a plurality of user profiles from users;
identify a first group of users from the user profiles having features matching a first group feature profile;
receive a first advertisement profile from an advertisement provider, each advertisement profile associated with its respective personalized advertising content;
provide access of the personalized advertising content by users of the user group responsively to assignment of the personalized advertisement profile to the first user group; and
wherein the databroker computing device is configured to:
use an assignment mechanism to assign a personalized advertisement profile to the user group, wherein the assignment mechanism includes a Price by Removal Mechanism (PRM) filtering users on a basis of user asking price greater than user asking price of users of other mediator computing devices;
establish a cost threshold based only on those mediator computing device costs reported to the databroker computing device;
apply the cost threshold to filter out users from a pool of potential users eligible for assignment to an advertiser;
establish a price threshold based only on those advertiser prices reported to the databroker computing device;
apply the price threshold to filter out advertisers from the pool of potential advertisers eligible for assignment to users;
enable viewing of the personalized advertising content by each of the users of the first group while concealing identity of each of the users of the first user group from the advertisement provider;
wherein the PRM has an access to a value γ≥1 such that:
u(a)≤γ∀a∈A and |P(m)|≤γ∀m∈M,
wherein
u(a) is a number of users to which an advertiser wants to advertise,
γ is an upper bound of advertiser capacity or the number of mediator users,
a is an advertiser,
m is a mediator or databroker unit, and
P(m) is the number of users a mediator m has in a particular profile.

12. (canceled)

13. The online, mediated advertising platform of claim 12, wherein the PRM includes filtering advertisers on a basis of advertiser offering price being less than offering price of other advertisers.

14. The online, mediated advertising platform of claim 11, wherein the assignment mechanism includes Threshold by Partition Mechanism (TPM) filtering users on a basis of payment thresholds.

15. The online, mediated advertising platform of claim 14, wherein the filtering users on a basis of payment thresholds includes:
randomly dividing mediator computing devices and advertisers into a first and a second pool, each of the pools has mediator computing devices and advertisers;
establishing a first-pool threshold and a second-pool threshold; and
filtering users of the second pool with the first-pool threshold and filtering users of the first pool with the second-pool threshold.

16. The online, mediated advertising platform of claim 11, wherein the assignment mechanism includes an Observe and Price Mechanism (OPM) filtering users on a basis of payment thresholds established during a sampling period of bidding prices of user and advertisers.

17. The online, mediated advertising platform of claim 11, wherein the enabling viewing of the personalized advertising content is implemented by sending the content.

18. The online, mediated advertising platform of claim 11, wherein each of the mediator computing devices is further configured to identify users having access to the personalized advertising content from the first user group, the access selected from the group consisting of a receipt of the content, a mouse click associated with the content, a user selection of an option presented in the content, and a tracked-eye motion indicative of content viewing.

19. The online, mediated advertising platform of claim 11, wherein each of the mediator computing devices is further configured to cause a payment transfer to the users having access to the personalized advertising content.

20. A method for implementing online, mediated advertising, performed on a databroker system including a plurality of network-enabled mediator computing devices coupled to a databroker computing device, each of the mediator computing devices and the databroker computing device having a processor, memory, and one or more code sets stored in the memory and executed in the processor, the method comprising:
receiving a plurality of user profiles from users by a first mediator computing device of the plurality of mediator computing devices;
designating a user group feature profile defining a first user group;
identifying a user group of users from the user profiles having features matching the group feature profile;
receiving a plurality of personalized advertisement profiles from an advertisement provider, each advertisement profile associated with its respective personalized advertising content;
using an assignment mechanism to assign a personalized advertisement profile to the first user group by the databroker computing device, wherein using the assignment mechanism includes a Threshold by Partition Mechanism (TPM) filtering users on a basis of payment thresholds;
wherein the filtering users on a basis of payment thresholds includes:
randomly dividing mediator computing devices and advertisers into a first and a second pool, each of the pools having mediator computing devices and advertisers;
establishing a first-pool threshold and a second-pool threshold; and
filtering users of the second pool with the first-pool threshold and filtering users of the first pool with the second-pool threshold;
and
enabling viewing of the personalized advertising content by each of the users of the first group while concealing an identity of each of the users of the first user group from the advertisement provider,
wherein each of above steps is implemented by the databroker system.
